(19) United States
(12) Patent Application Publication
(10) Pub. No.: US 2005/0176374 A1
(43) Pub. Date: Aug. 11, 2005

(54) ADJUSTABLE WIRELESS COMMUNICATION DEVICE AND ANTENNA MODULE AND CONTROL METHOD THEREOF

(76) Inventors: Chien-Hsing Fang, Taipei Hsien (TW); Ho-Chen Chang, Taipei Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/905,224

(22) Filed: Dec. 22, 2004

(30) Foreign Application Priority Data
Feb. 9, 2004 (TW) 093102974

(51) Int. Cl. H04B 1/00

(52) U.S. Cl. 455/63.4; 343/850; 455/63.3; 343/824

(57) ABSTRACT

An adjustable wireless communication device and an antenna module for transmitting radio signals includes a plurality of antennas arranged in an array, and a control circuit connected to the plurality of antennas for switching on a subset of antennas among the plurality of antennas. When the control circuit switches on fewer antennas among the plurality of the antennas, the directivity of the radiation pattern of the antenna module is weaker; and when the control circuit switches on more antennas among the plurality of the antennas, the directivity of the radiation pattern of the antenna module is stronger.

### BACKGROUND OF INVENTION

1. Field of the Invention

The present invention relates to an antenna module, and more particularly, to an antenna module having an adjustable radiation field.

2. Description of the Prior Art

In modern society, data is required to be accessible anytime and anywhere. As such, wireless communication devices are the best choice. As technology progresses, portable wireless communication devices such as mobile phones and personal digital assistants (PDA) play an important role in modern life.

In each wireless communication device, an antenna used for receiving and transmitting radio waves is an important component. Especially in portable wireless communication devices, antennas are not only required to be compact in size, but are also required to have a larger bandwidth as the integration of radio data signals (bits per unit time) increases.

When using normal antennas with different receiving and transmitting requirements, different coverage areas are needed according to different services to users. For example, if a specific service area has a large users load, corresponding antenna devices have to change their radiation patterns by becoming more directive to the specific area so that the receiving covering areas of the antenna devices can cover the corresponding area of services to users. Additionally, if the specific service area has a smaller user load, the corresponding antenna devices can help other antenna devices share their loads so that the antenna devices corresponding to the specific area have to change their radiation patterns by becoming more wide instead of directive for covering areas of other antenna devices. However, antennas according to prior art can not change radiation patterns according to different demands of services, such as receiving covering areas, or directivities, so that the design of antennas lacks for flexibility.

### SUMMARY OF INVENTION

It is therefore an objective of the claimed invention to provide an antenna module to solve the above-mentioned problems by changing its radiation pattern.

According to the claimed invention, an antenna module for transmitting radio signals includes: a plurality of antenna units which are arranged in an array; and a control circuit electrically connected to the plurality of antenna units for selectively turning on a subset of the antenna units; wherein if the control circuit turns on fewer number of antenna units, the antenna module forms a radiation pattern having weaker directivity, and if the control circuit turns on a greater number of the antenna units, the antenna module forms a radiation pattern having stronger directivity.

A wireless communication device includes: a shell having a first shielding surface for shielding electromagnetic waves; a data processing module; a wireless communication module electrically connected to the data processing module; and an antenna module includes: a plurality of antenna units set up on the first shielding surface; and a control circuit electrically connected to the plurality of antenna units and the wireless communication module for selectively turning on a subset of the plurality of antenna units; wherein if the control circuit turns on fewer number of the antenna units, the antenna module forms a radiation pattern having weaker directivity, and if the control circuit turns on a greater number of the antenna units, the antenna module forms a radiation pattern having stronger directivity.

A wireless communication device for exchanging data with a plurality of users, the wireless communication device includes: a shell comprising a first surface and a second surface, wherein the first surface is adjacent to the second surface having an angle between the first surface and the second surface; a data processing module; a wireless communication module electrically connected to the data processing module; a first antenna module being set up on the first surface and driven by the wireless communication module for emitting a first electromagnetic wave signal with a first frequency, wherein the first antenna module can switch into a first emitting mode and a second emitting mode, and a coverage angle of the radiation field of the first emitting mode is wider than a coverage angle of the radiation field of the second emitting mode; a second antenna module being set up on the second surface and driven by the wireless communication module for emitting a second electromagnetic wave signal with a second frequency, wherein the first antenna module can switch into a first emitting mode and a second emitting mode, and a coverage angle of the radiation field of the first emitting mode is wider than a coverage angle of the radiation field of the second emitting mode; a first switching circuit electrically connected to the first antenna module for switching the first antenna module into the first emitting mode or into the second emitting mode; and a second switching circuit electrically connected to the second antenna module for switching the second antenna module into the first emitting mode or into the second emitting mode.

A wireless communication controlling method for controlling a wireless communication device to exchange data with a plurality of users, the wireless communication device includes a shell having a first surface, a second surface adjacent to the first surface, and an angle between the first surface and a second surface; a first antenna module set up on the first surface for emitting a first electromagnetic wave signal with a first frequency, wherein the first antenna can switch into a first emitting mode and a second emitting mode; a second antenna module set up on the second surface for emitting a second electromagnetic wave signal with a second frequency, wherein the second antenna module can switch into the first emitting mode and the second emitting mode, a coverage angle of the first emitting mode being wider than a coverage angle of the second emitting mode, the communication controlling method includes: calculating a first number of users who exchange data with the wireless communication device through the first antenna module; calculating a second number of users who exchange data with the wireless communication device through the second antenna module; and controlling emitting modes of the first antenna module and the second antenna module according to the first number and the second number.

A wireless communication controlling method for controlling a wireless communication device to exchange data with a plurality of users, the wireless communication device includes a shell having a first surface, a second surface adjacent to the first surface, and an angle between the first surface and a second surface; a first antenna module set up on the first surface for emitting a first electromagnetic wave signal with a first frequency, where the first antenna can switch into a first emitting mode and a second emitting mode; a second antenna module set up on the second surface for emitting a second electromagnetic wave signal with a second frequency, wherein the second antenna module can switch into the first emitting mode and the second emitting mode, a coverage angle of the first emitting mode is wider than a coverage angle of the second emitting mode, the communication controlling method includes: calculating a first data flow of exchanging data with the wireless communication device through the first antenna module; calculating a second data flow of exchanging data with the wireless communication device through the second antenna module; and controlling the emitting modes of the first antenna module and the second antenna module according to the first data flow and the second data flow.

It is an advantage of the claimed invention to provide a design of an antenna module capable of changing its radiation pattern, additionally, to provide a complex antenna module and a method of controlling antenna modules, so that the antenna module according to the present invention can provide different radiation patterns according to different demands of coverage areas of services to users.

These and those objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of a wireless communication device according to the present invention.

FIG. 2 is a diagram of an antenna module of the first embodiment according to the present invention.

FIG. 3 is a diagram of circuit structures of a control switch module of the antenna module.

FIG. 4 is a radiation pattern when only one of the antennas is turned on.

FIG. 5 illustrates a radiation pattern when the antenna 16a and the antenna 16b are both turned on.

FIG. 6 is a diagram of an antenna module of the second embodiment according to the present invention.

FIG. 7 is a radiation pattern when the antennas 26a, 26b, 26c are all turned on.

FIG. 8 is a diagram of an antenna module of the third embodiment according to the present invention.

FIG. 9 is a five-view diagram of the antenna module.

FIG. 10 is a diagram of the antenna 56a connected to the shielding surface 54a.

FIG. 11 is a diagram of each antenna shares channels of a wireless communication device in the third embodiment.

FIG. 12 illustrates a radiation pattern when only one antenna unit of the antenna 56d is turned on of the third embodiment.

FIG. 13 illustrates a radiation pattern when two antenna units of the antenna 56d are turned on.

FIG. 14 is a block diagram of a wireless communication device of the third embodiment according to the present invention.

FIG. 15 illustrates a radiation pattern when the antenna 56a is in the first emitting mode and the antenna 56d is in the second emitting mode of the third embodiment.

FIG. 16 illustrates a radiation pattern when the antenna 56c is in the second emitting mode and the antennas 56d, 56e are in the first emitting mode of the fourth embodiment according to the present invention.

FIG. 17 illustrates a radiation pattern when the antenna 56c is in the first emitting mode and the antennas 56d, 56e are in the second emitting mode of the fifth embodiment according to the present invention.

FIG. 18 illustrates a radiation pattern when the antenna 56d is in the first emitting mode and the antennas 56c, 56e are in the second emitting mode of the sixth embodiment according to the present invention.

### DETAILED DESCRIPTION

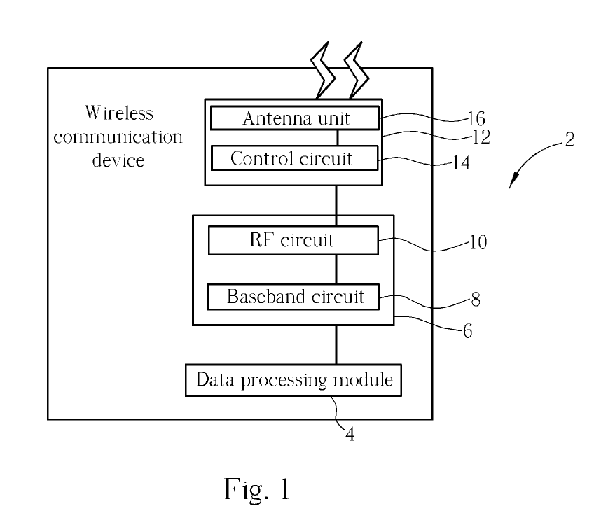

Please refer to FIG. 1, which is a block diagram of a wireless communication device 2. The wireless communication device 2 includes a data processing module 4 for controlling the operation of the wireless communication device 2, a wireless communication module 6 having a baseband circuit 8 and a radio frequency (RF) circuit 10, and an antenna module 12 which includes a control circuit 14 and a plurality of antenna units 16 connected to the control circuit 14. The data processing module 4 transmits communication signals to the baseband circuit 8. The baseband circuit 8 encodes the communication signals into baseband signals, which are then transmitted to the RF circuit 10. The RF circuit 10 modulates the baseband signals and emits them with a radio frequency by using the antenna module 12. The RF circuit 10 can also receive RF signals by using the antenna module 12 and demodulate them into baseband signals for the baseband circuit 8 to decode into communication signals, which are then transmit to the data processing module 4 to achieve the function of wireless data transmitting. Additionally, the data processing module 4 emits signals to the control circuit 14 for selectively turning on antenna units of the antenna module 12. The radio signals of the antenna module 12 comply with the IEEE 802.11a, IEEE 802.11b, or IEEE 802.11g standards.

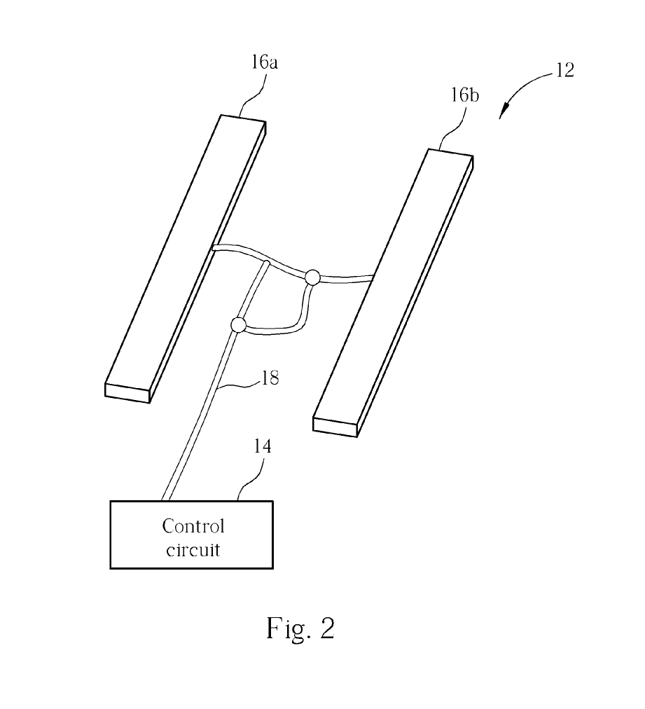

Please refer to FIG. 2, which is a diagram of an antenna module of the first embodiment according to the present invention. The antenna 16 of antenna module 12 includes two antenna units 16a and 16b, which can be all kinds of antenna units and are arranged in an array. The antenna module 12 further includes a control switch module 18 connected to the two antenna units 16a, 16b and a control circuit 14 for controlling the electrical connection between the antenna units 16a, 16b and the control circuit 14.

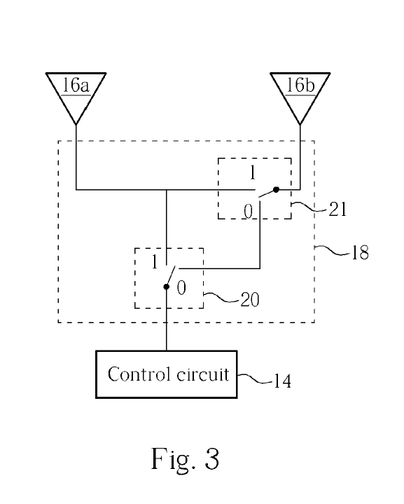

Please refer to FIG. 3, which is a diagram of circuit structures of the control switch module 18 of the antenna module 12. As shown in FIG. 3, the control switch module 18 includes a first control switch 20 and a second control switch 21 which are single-pole double-throw switches. This means the two control switches 20, 21 can receive two signals and utilize the characteristic of single-pole double-throw switches to switch into two different positions. For example, if the control circuit 14 receives a control signal from the data processing module 4 to turn on one of the two antennas, a signal with signal value 0 is transmitted to the control switch module 18 so that the first control switch 20 and the second control switch 21 are switched into the position 0 in FIG. 3. Therefore, the connection between the control circuit and the antenna unit 16b is established, but the connection between the control circuit and the antenna unit 16a is broken. This means that only the antenna unit 16b can transmit RF signals to the RF circuit 10 so that only the antenna unit 16b is turned on. Additionally, if the antenna units 16a, 16b are both needed to be turned on, a signal with a signal value 1 is transmitted to the control switch module 18 so that the first control switch 20 and the second control switch 21 are switched into the position 1 in FIG. 3. It can be easily seen that the connections between the antenna unit 16a and the control circuit 14 and the antenna unit 16b and the control circuit 14 are both established so that the antenna units 16a, 16b can transmit RF signals to the RF circuit 10. Additionally, it can also be designed that the first control switch and the second control switch are switched into position 0 if a signal with a signal value 1 is transmitted to the control switch module 18 so that the antenna unit 16b is turned on. The method of selectively turning on the antenna units of the present invention control switch module 18 is not limited as utilizing single-pole double-throw switches but any other forms of switches. For example, a plurality of switches can be used and each switch corresponds to a antenna unit for establishing the connection between the antenna units and the control circuit 14 and further control the antenna units.

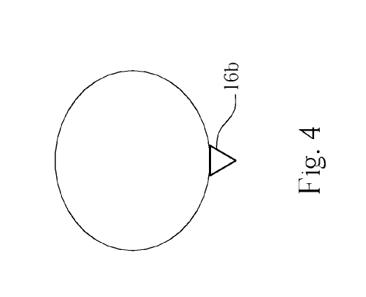

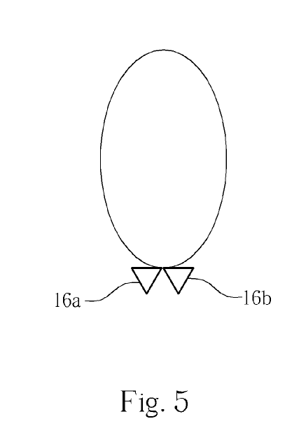

Please refer to FIG. 4 and FIG. 5, which illustrate the radiation pattern of the antenna 16 in different conditions. While transmitting, because a metal shielding surface is positioned in back of the antenna 16 (not shown in FIG. 4 and FIG. 5), the electromagnetic wave is transmitted to the front side of the antenna 16. FIG. 4 is a radiation pattern when only one of the antennas is turned on, and FIG. 5 illustrates a radiation pattern when the antenna 16a and the antenna 16b are both turned on. From FIG. 4 and FIG. 5, when the control switch module 18 only turns on the antenna unit 16b, the antenna module 12 forms a radiation pattern with a weaker directivity but a wider coverage area, and when the control switch module 18 turns on the antenna units 16a, 16b, the antenna module 12 forms a radiation pattern with a stronger directivity but a more narrow coverage area. This means when the control circuit 14 turns on a fewer number of antenna units 16, the antenna module 12 forms a radiation pattern with a weaker directivity, but when the control circuit turns on a greater number of antenna units, the antenna module forms a radiation pattern with a stronger directivity.

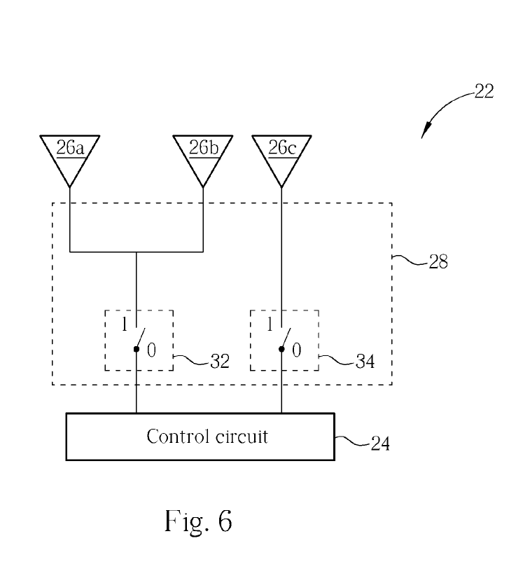

The number of the antenna units of the antenna module is not limited to 2. Other numbers are also available, as long as the control switch module is well-designed that the control switch module is able to selectively turn on subsets of antenna units. Please refer to FIG. 6, which is a diagram of an antenna module 22 of the second embodiment according to the present invention. The antenna module 22 includes three antenna units 26a, 26b, 26c, which can be all forms of antennas and are arranged in an array, a control switch module 28 electrically connected to three antenna units 26a, 26b, 26c, and a control circuit 24 electrically connected to the control switch module 28 for controlling the control switch module 28 to selectively turn on parts of antenna units 26 of antenna module 22. The control switch module 28 includes a third control switch 32 and a fourth control switch 34, wherein the operational methods of the third switch 32 and the fourth control switch 34 are the same as the operational methods of the first and the second switch of the first embodiment. Similarly, if the control circuit 24 has to turn on one of the three antenna units, a signal with signal value 0 is transmitted into the third control switch 32 and another signal with signal value 1 is transmitted into the fourth control switch 34 so that only the connection between the antenna unit 26c and control circuit is established. This means only antenna unit 26c is turned on and allowed to transmit signal. On the other hand, if the control circuit 24 has to turn on two of the three antenna units, a signal with signal value 1 is transmitted into the third control switch 32 and another signal with signal value 0 is transmitted into the fourth control switch 34 so that only the connections between the control circuit 24 and the antenna units 26a, 26b are established. This means two antenna units 26a, 26b are turned on and allowed to transmit signals. Additionally, if the control circuit 24 has to turn on all the three antenna units 26a, 26b, 26c, a signal with signal value 1 is transmitted into both the third control switch 32 and the fourth control switch for establishing the connections between the control circuit 24 and the three antenna units 26a, 26b, 26c so that all three antenna units 26a, 26b, 26c are turned and allowed to transmit signals. Additionally, if the control circuit has to turn off all antenna units 26a, 26b, 26c, a signal with signal value 0 is transmitted into the third control switch 32 and the fourth control switch 34 for breaking the connections between the control circuit 24 and the three antenna units 26a, 26b, 26c. This means three antenna units are all turned off.

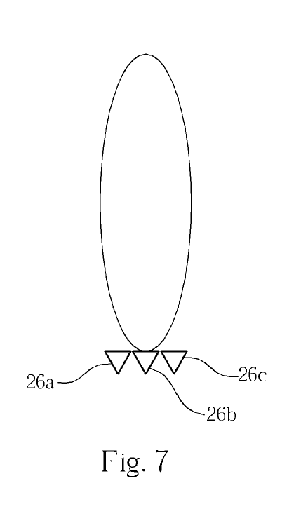

Similar to the first embodiment, when the control circuit 24 turns on a fewer number of antenna units 26, the antenna module 22 forms a radiation pattern with weaker directivity, but when the control circuit turns on a greater number of antenna units 26, the antenna module 22 forms a radiation pattern with stronger directivity. When the antenna unit 26c is only utilized to transmit signals, the radiation pattern is similar to that shown in FIG. 4. When two antenna units 26a, 26b are utilized to transmit signals, the radiation pattern is similar to that shown in FIG. 5. Please refer to FIG. 7, which illustrates a radiation pattern when the antennas 26a, 26b, 26c are all turned on. As shown in FIG. 4, FIG. 5, and FIG. 7, it can be seen that when antenna units 26a, 26b, 26c are all turned on, the antenna module 22 forms a radiation pattern having stronger directivity and a more narrow coverage area than when only one or two antenna units are turned on.

The number of antenna units (such as 2 or 3) of the antenna module is only used for an illustration, and is not a limitation of the present invention. In fact, the number of antenna module can be changed according to design requirements. In general, when fewer antenna units are turned on, the antenna module forms a radiation pattern with a weaker directivity, but when more antenna units are turned on, the antenna module forms a radiation pattern with a stronger directivity.

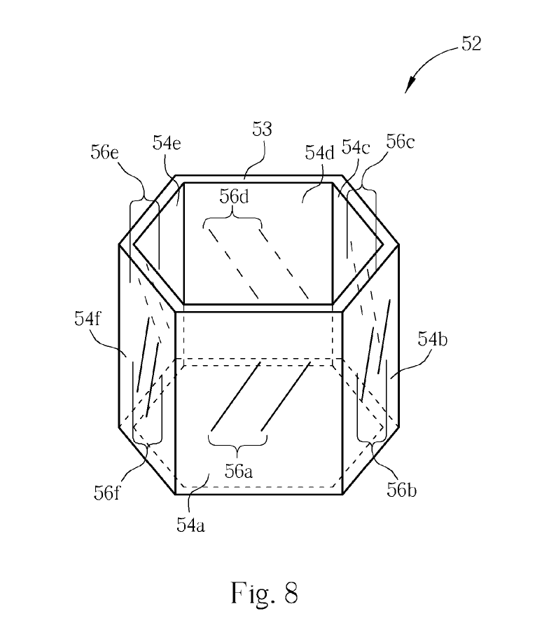

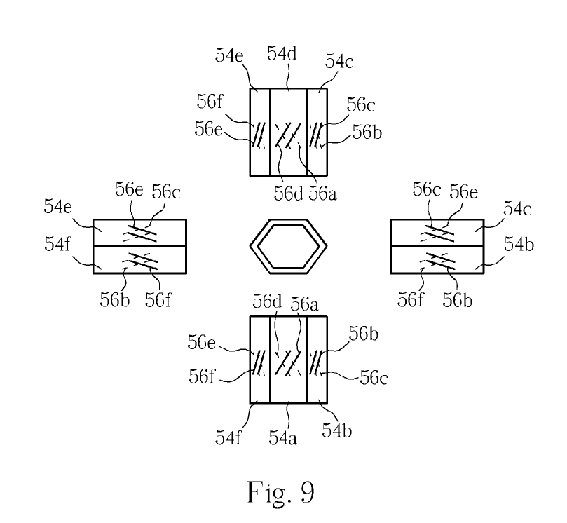

Please refer to FIG. 8 and FIG. 9. FIG. 8 is a diagram of an antenna module 52 of the third embodiment according to the present invention. FIG. 9 is a five-view diagram of the antenna module 52. The antenna module 52 includes a shell 53 being a hexagon. The shell 12 includes six metal shielding surfaces 54a-54f formed on the six surfaces of the hexagon for shielding radio signals, and six antenna units 56a-56f formed respectively on the six shielding surfaces 54a-54f, arranged in the same direction, and having an angle of 45 degrees with the bases of the six shielding surfaces 54a-54f, respectively. The data processing module 4 and the wireless communication module 6 (not shown in either FIG. 8 or FIG. 9) are installed inside the shell 53 for processing radio signals received or transmitted. The wireless communication module 6 can be a single independent module controlling the six antenna units 56a-56f, or be composed of six communication units, each controlling one of the antenna units. It is an advantage of the latter implementation that if any communication unit fails, only that single part must be replaced instead of the whole wireless communication module 6.

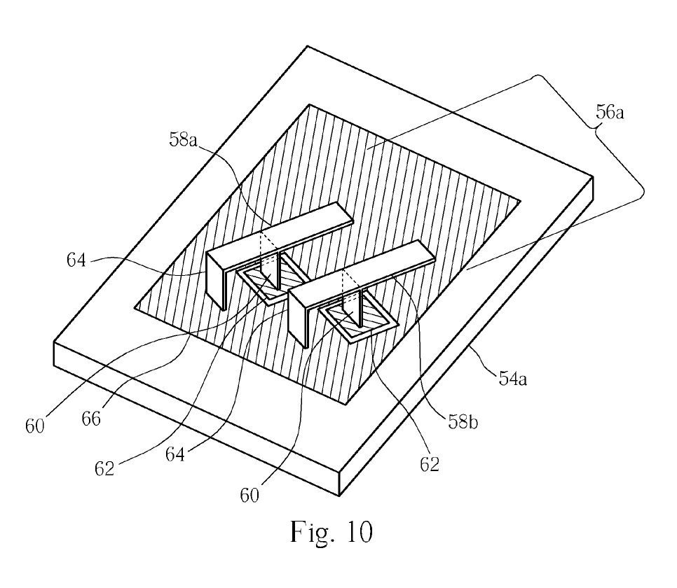

Please refer to FIG. 10, which is a diagram of the antenna 56a connected to the shielding surface 54a. The antenna unit 56a can be a planar inverted F antenna (PIFA) or another antenna that is connected to the shielding surface 54a. The antenna unit 56a includes two antenna units 58a, 58b which are arranged in an array and parallel for receiving and transmitting RF signals. Two feeding ends 60 stretching out from the antenna units 58a, 58b are connected perpendicularly to two signal transmitting ends 62 of the shielding surface 54a for transmitting RF signals, and two ground ends 64 stretching out from the antenna units 58 are connected perpendicularly to a ground plane 66 of the shielding surface 54a. The antenna unit 56a transmits and receives RF signals by using the resonance of the antenna units 58a, 58b, and the transmission of RF signals between the antenna unit 56a and the RF circuit 8 relies on the connection between the feeding end 60 of the antenna unit 56a and the signal transmitting end 62 of the shielding surfaces 54a. The antenna unit 56a is not limited to include two antenna units 58a, 58b. A single antenna unit or another number of antenna units is also possible. The connections between the other five antenna units 56b-56f and the other five shielding surfaces 54b-54f are the same as shown in FIG. 10. The antenna unit 56 can be connected to the shielding surface 54 in other manner and is not limited to the aforementioned description.

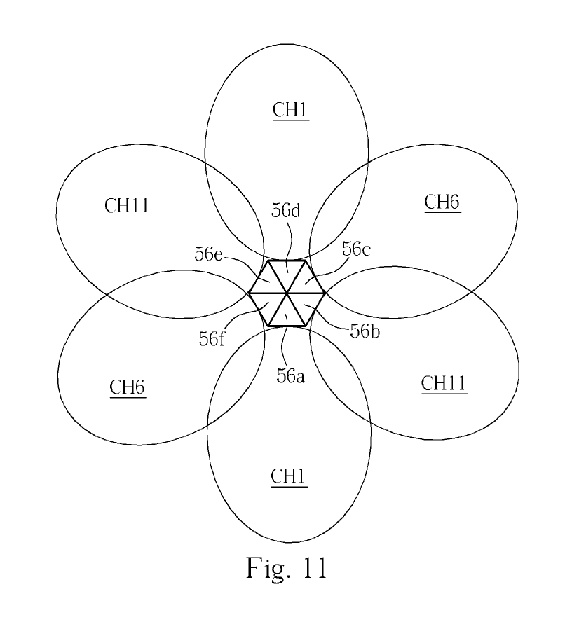

According to the present invention, the antenna units on two parallel shielding surfaces are perpendicular to each other. That is, the antenna unit 56a on the shielding surface 54a is perpendicular to the antenna unit 56d on the shielding surface 54d, the antenna unit 56b on the shielding surface 54b is perpendicular to the antenna unit 56e on the shielding surface 54e, and the antenna unit 56c on the shielding surface 54c is perpendicular to the antenna unit 56f on the shielding surface 54f. In such a manner, the polarity directions of the antenna units on two parallel shielding surfaces are perpendicular to each other so that the signal isolation between the two antenna units is increased. For instance, if the wireless communication device 2 is for providing IEEE 802.11b or IEEE 802.11g LAN service, since three channels, such as CH1, CH6 and CH11 can be used within a band of 2.4 GHz (2.4-2.4835 GHz), the interference caused by the main lobe overlap can be reduced. Please refer to FIG. 11 showing the antenna units of the wireless communication device 2 sharing the channels. As shown in FIG. 11, signal channels used by the antenna units on two parallel shielding surfaces are the same. That is, the antenna units 56a and 56d use CH1, the antenna units 56b and 56e use CH11, and the antenna units 56c and 56f use CH6. In such a manner, the antenna units on two adjacent shielding surfaces do not use the same channel or even two channels close in frequency to prevent the interference between each other. And although the antenna units on two parallel surfaces use the same channel, since the direction of emission is opposite to each other and there is a metal shield between the two antenna units, interference does not occur. In addition, indirect interference caused by environmental radio reflection should be considered. Since the antenna units on two parallel shielding surfaces are perpendicular to each other, the radio polarities of the antenna units are accordingly perpendicular to each other. Therefore, even if the same channel is used, radio waves caused by reflection or scattering will be received by an antenna unit on the opposite shielding surface and the interference will be reduced to a minimum. Moreover, the wireless communication device 2 uses six antenna units for wireless data transmission, so that the transmission throughput is ideally six times that of a single AP. In other words, if the maximum transmission throughput of an AP is 11 Mbps, the wireless communication device 2 according to the present invention provides a maximum transmission throughput of 11*6=66 Mbps.

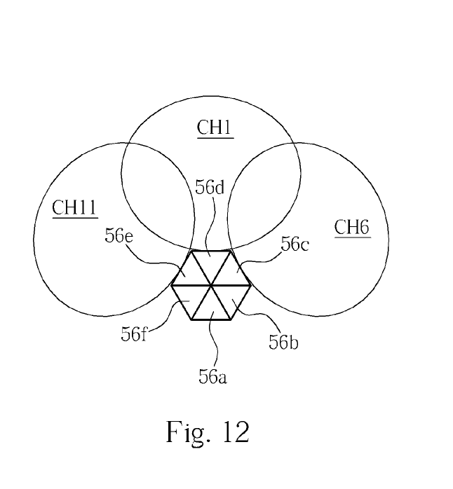

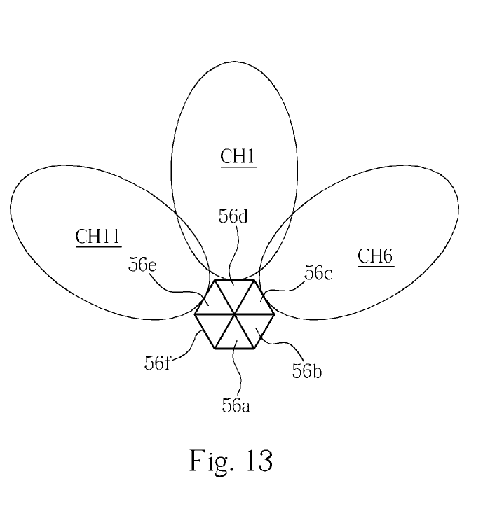

Please refer to FIG. 12 and FIG. 13. FIG. 12 illustrates a radiation pattern when only one antenna unit of the antenna 56d is turned on of the third embodiment. FIG. 13 illustrates a radiation pattern when two antenna units of the antenna 56d are turned on. When the loads of the user service area are larger than provided by the antenna 56d, two antenna units of antenna 56d can be turned on for forming a radiation pattern with a stronger directivity, so that the coverage area only has to cover the service area. At this time, the antenna is termed as being in a second emitting mode. On the other hand, when the loads of the user service area are reduced, the antenna 56d can help neighboring antennas 56c, 56e, therefore, only one antenna unit of antenna 56d has to be turned on for forming a radiation pattern with a wider coverage area instead of stronger directivity. As a result, the coverage area can cover the service area of neighboring antennas and the antenna 56d can share the loads of other antennas. At this time, the antenna is termed as being in a first emitting mode.

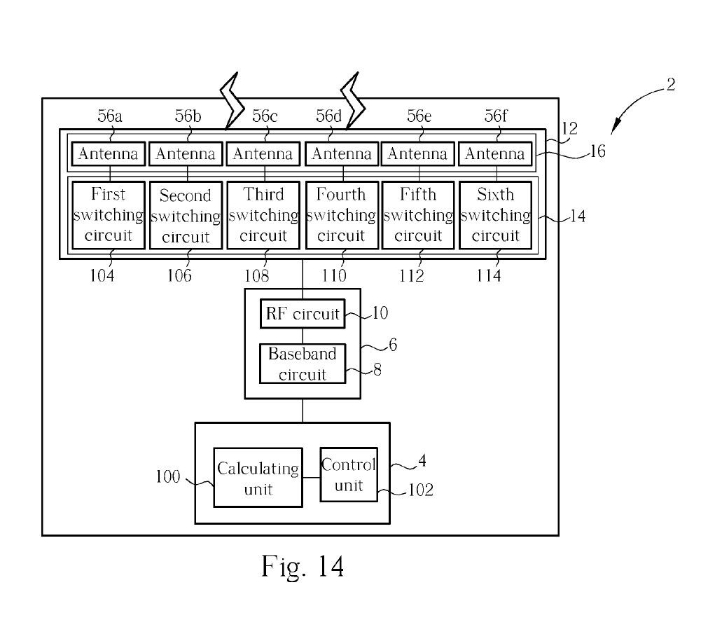

Please refer to FIG. 14, which is a block diagram of a wireless communication device 2 of the third embodiment according to the present invention. As shown in FIG. 14, the data processing module 4 includes a calculating unit 100 and a control unit 102. In the antenna module 12, the control circuit 14 includes a first switching circuit 104, a second switching circuit 106, a third switching circuit 108, a fourth switching circuit 110, a fifth switching circuit 112, and a sixth switching circuit 114, which are respectively and electrically connected to antennas 56a, 56b, 56c, 56d, 56e, 56f for switching the emitting modes of the six antennas. The calculating unit 100 of the data processing module 4 can calculate the number of users who exchange data with the wireless communication device 2 through six antennas. The control unit 102 controls the six switching circuits of the control circuit 14 according to the results of the calculating unit 100.

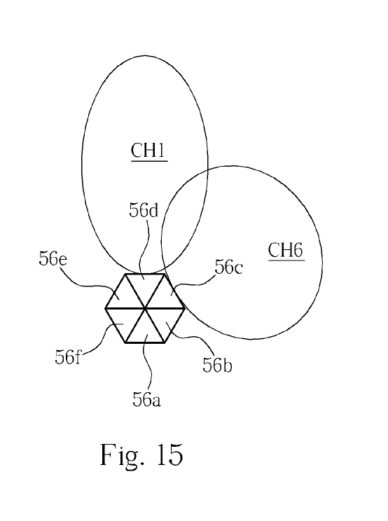

For example, the calculating unit 100 of the data processing module 4 calculates a first number of users who exchange data with the wireless communication device 2 through the antenna 56d and a second number of users who exchange data with the wireless communication device 2 through the antenna 56c. When the first number is larger than the second number, the control unit 102 controls the fourth switching circuit 110 to switch the antenna 56d into the second emitting mode, and the control unit 102 controls the third switching circuit 108 to switch the antenna 56c into the first emitting mode. Please refer to FIG. 15, which illustrates a radiation pattern when the antenna 56a is in the first emitting mode and the antenna 56d is in the second emitting mode in the third embodiment. As shown in FIG. 15, when the user load of the service area of antenna 56d is larger (this also means the number of users who exchange data with the wireless communication device 2 through the antenna 56d is larger), two antenna units of the antenna 56d are turned on for forming a radiation pattern with a stronger directivity so that the covering area only has to cover the service area. (Therefore antenna 56d is in the second emitting mode.) As the user load of the service area of antenna 56c is lower than that of antenna 56d, the antenna 56c can help antenna 56d share loads. At this time, only one antenna unit of antenna 56c is turned for forming a radiation pattern with wider coverage area instead of stronger directivity so that coverage area can also help cover the service area of antenna 56d. (Therefore antenna 56c is in the first emitting mode.) At this time, some of the users utilize antenna 56c instead of antenna 56d.

Additionally, in the above-mentioned embodiments, the loads of the service area of antenna 56c and antenna 56d are determined by the number of users. However, data flow in a time duration can also be used for determining the loads. For example, when the calculating unit 100 of the data processing module 4 calculates a first data flow of exchanging data with the wireless communication device 2 through the antenna 56d and a second data flow of exchanging data with the wireless communication device 2 through the antenna 56c, and the first data flow is larger than the second data flow, the control unit 102 controls the fourth switching circuit 110 to switch the antenna 56d into the second emitting mode, and the control unit 102 controls the third switching circuit 108 to switch the antenna 56c into the first emitting mode. Similarly, when the first data flow and the second data flow are both less than a predetermined value, the control unit 102 controls the fourth switching circuit 110 to switch the antenna 56d into the second emitting mode and controls the third switching circuit 108 to switch the antenna 56c into the second emitting mode. Because the loads of service area of the antennas 56c, 56d are both less than specific loads, there's no need to share loads so that the coverage area of each antenna only has to cover the service area of each antenna.

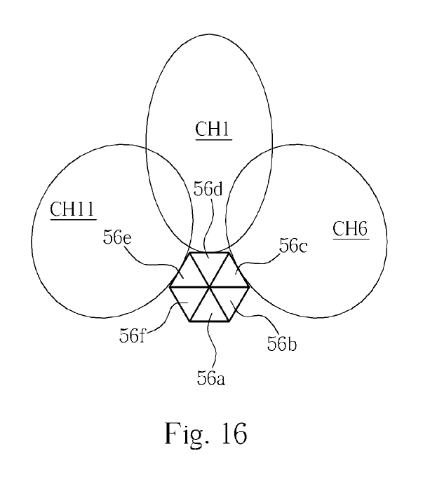

Please refer to FIG. 16, which illustrates a radiation pattern when the antenna 56c is in the second emitting mode and the antennas 56d, 56e are in the first emitting mode of the fourth embodiment according to the present invention. When the load of the service area of antenna 56d is larger (the number of users or data flow of exchanging data with the wireless communication device 2 through the antenna 56d is larger), two antenna units of the antenna 56d can be turned on for forming a radiation pattern with stronger directivity wherein the coverage area of the antenna 56d only has to cover the service area (antenna 56d is in the second emitting mode). If the loads of the service areas of antennas 56c, 56e are lower than that of antenna 56d, the antennas 56c, 56e can help the antenna 56d. At this time, only one antenna unit of antennas 56c, 56e is turned on for forming a radiation pattern having a wider coverage area so that the coverage area can cover the service area of antenna 56d to share the loads. As such, a subset of users are changed to utilize antennas 56c and 56e.

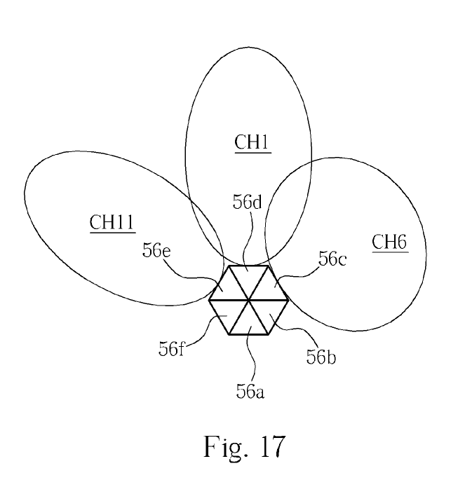

Please refer to FIG. 17, which illustrates a radiation pattern when the antenna 56c is in the first emitting mode and the antennas 56d, 56e are in the second emitting mode in the fifth embodiment according to the present invention. Similarly, the loads of the service areas of antennas 56d, 56e are larger, and the load of the service area of 56c is lower than those of antennas 56d, 56e. Two antenna units of antennas 56d, 56e are turned on for forming a radiation pattern with stronger directivity wherein the coverage area of the antennas 56d, 56e only has to cover the service areas of antenna 56d, 56e. (The antennas 56d, 56e are in the second emitting mode.) The antenna 56c is in the first emitting mode for forming a radiation pattern with wider coverage area so that the coverage area of antenna 56c can cover the service area of antennas 56d, 56e to share loads.

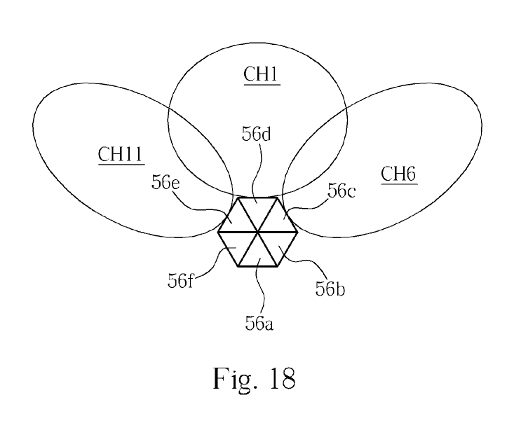

Please refer to FIG. 18, which illustrates a radiation pattern when the antenna 56d is in the first emitting mode and the antennas 56c, 56e are in the second emitting mode in the sixth embodiment according to the present invention. Similarly, when the loads of the service areas of antennas 56c, 56e are larger (the number of users or data flow of exchanging data with the wireless communication device 2 through the antennas 56c, 56e are larger), two antenna units of the antennas 56c, 56e can be turned on for forming a radiation pattern with stronger directivity wherein the coverage areas of the antennas 56c, 56e only have to cover the service area of antennas 56c, 56e (the antennas 56c, 56e are in the second emitting mode); and if loads of the service area of antenna 56d is lower than that of antennas 56c, 56e, the antenna 56d can help the antennas 56c, 56e. At this time, only one antenna unit of antenna 56d is turned on for forming a radiation pattern with wider coverage area so that the coverage area can cover the service areas of antennas 56c, 56e to share loads. As such, a subset of users are changed to utilize antenna 56d.

The present invention provides a design of antenna module having a changeable radiation pattern so that the present invention can provide different radiation patterns according to different loads of service areas. For example, when loads of service areas of a wireless communication device are larger, the antenna module can turn a greater number of antennas for forming a radiation pattern with stronger directivity. So, the coverage area can cover the service area. When loads of serving areas of a wireless communication device are lower, the wireless communication device can help neighboring wireless communication devices to share loads. At this time the antenna module turns on fewer number of antennas for forming a radiation with wider coverage area instead of stronger directivity. So, the coverage area of the wireless communication device can cover the service area of other wireless communication devices to share loads. Therefore, the antenna module according to the present invention can change according to the service demands such as changes of coverage area or directivity of antennas so that the design of arranging antennas is more flexible.

Those skilled in the art will readily observe that numerous modifications and alterations of the device may be mode while retaining the teachings of the invention. Accordingly, the above disclosure should be construed as limited only by the metes and bounds of the appended claims.

1. An antenna module for transmitting radio signals comprising:
a plurality of antenna units which are arranged in an array; and
a control circuit electrically connected to the plurality of antenna units for selectively turning on a subset of the antenna units;
wherein if the control circuit turns on fewer number of antenna units, the antenna module forms a radiation pattern having weaker directivity, and if the control circuit turns on a greater number of the antenna units, the antenna module forms a radiation pattern having stronger directivity.

2. The antenna module of claim 1, further comprising a plurality of control switches used for controlling the electrical connections between the plurality of antenna units and the control circuit.

3. The antenna module of claim 2, wherein the control switches are single-pole double-throw switches.

4. The antenna module of claim 1, wherein the radio signals comply with the IEEE 802.11a standard.

5. The antenna module of claim 1, wherein the radio signals comply with the IEEE 802.11b standard.

6. The antenna module of claim 1, wherein the radio signals comply with the IEEE 802.11g standard.

7. The antenna module of claim 1, wherein the plurality of antenna units comprises a first antenna unit and a second antenna unit; and the antenna module further comprises a first control switch and a second control switch used for controlling the connection between the first antenna unit and the control circuit, and between the second antenna unit and the control circuit.

8. The antenna module of claim 7, wherein the first control switch and the second control switch are both single-pole double-throw switches.

9. The antenna module of claim 7, wherein when the first control switch and the second control switch simultaneously receive a first signal, and the first antenna unit and the second antenna unit are simultaneously turned on.

10. The antenna module of claim 7, wherein the first control switch and the second control switch simultaneously receive a second signal, and one of the first antenna unit and the second antenna unit is turned on.

11. The antenna module of claim 1, wherein the plurality of antenna units comprises a third antenna, a fourth antenna unit, and a fifth antenna unit, the antenna module further comprises a third control switch and a fourth control switch used for controlling the third antenna unit, and the fourth antenna unit and the fifth antenna unit are electrically connected to the control circuit.

12. The antenna module of claim 11, wherein the third control switch and the fourth control switch are single-pole double-throw switches.

13. The antenna module of claim 11, wherein when the third control switch receives a third signal, the third antenna unit and the fourth antenna unit are turned on simultaneously.

14. The antenna module of claim 11, wherein when the fourth control switch receives a fourth signal, the fifth antenna unit is turned on.

15. The antenna module of claim 11, wherein the third control switch and the fourth control switch simultaneously receive a fifth signal, the first antenna unit, the second antenna unit, and the third antenna unit are turned on simultaneously.

16. The antenna module of claim 11, wherein the third control switch and the fourth control switch simultaneously receive a sixth signal, the first antenna unit, the second antenna unit, and the third antenna unit are turned off simultaneously.

17. The antenna module of claim 11, wherein the number of the plurality of control switches is the same as the number of the plurality of antenna units, and the control switches are respectively connected to the antenna units through a one to one connection.

18. A wireless communication device comprising:
a shell having a first shielding surface for shielding electromagnetic waves;
a data processing module;
a wireless communication module electrically connected to the data processing module; and
an antenna module comprising:
a plurality of antenna units set up on the first shielding surface; and
a control circuit electrically connected to the plurality of antenna units and the wireless communication module for selectively turning on a subset of the plurality of antenna units;
wherein if the control circuit turns on fewer number of the antenna units, the antenna module forms a radiation pattern having weaker directivity, and if the control circuit turns on a greater number of the antenna units, the antenna module forms a radiation pattern having stronger directivity.

19. The wireless communication device of claim 18, wherein the antenna module further comprises a plurality of control switches used for controlling the electrical connection between the plurality of antenna units and the control circuit.

20. The wireless communication device of claim 19, wherein the plurality of control switches are single-pole double throw switches.

21. The wireless communication device of claim 18, wherein the radio signals transmitted by the wireless communication device comply with the IEEE 802.11a standard.

22. The wireless communication device of claim 18, wherein the radio signals transmitted by the wireless communication device comply with the IEEE 802.11b standard.

23. The wireless communication device of claim 18, wherein the radio signals transmitted by the wireless communication device comply with the IEEE 802.11g standard.

24. The wireless communication device of claim 18, wherein the shell further comprises a second shielding surface, and the antenna module further comprises a plurality of antenna units set up on the second shielding surface.

25. The wireless communication device of claim 18, wherein the antenna module comprises a first antenna unit and a second antenna unit set up on the first shielding surface.

26. The wireless communication device of claim 25, wherein the shell further comprises a second shielding surface, and the antenna module comprises a third antenna unit and a fourth antenna unit setup on the second shielding surface.

27. The wireless communication device of claim 26, wherein the first antenna unit and the second antenna unit are driven by the wireless communication module for emitting a first electromagnetic wave, and the third antenna unit and the fourth antenna unit are driven by the wireless communication module for emitting a second electromagnetic wave; wherein the direction of polarity of the first electromagnetic wave and the direction of polarity of the second electromagnetic wave are orthogonal.

28. The wireless communication device of claim 27, wherein the first electromagnetic wave and the second electromagnetic wave correspond to the same channel.

29. The wireless communication device of claim 25, wherein the first antenna unit and the second antenna unit are arranged substantially in parallel.

30. The wireless communication device of claim 29, wherein the angle between the first projection on the first shielding surface of the central axis of the shell and the first antenna unit is 45 degrees, and the angle between the first projection on the first shielding surface of the central axis of the shell and the second antenna unit is 45 degrees.

31. The wireless communication device of claim 25, wherein the third antenna unit and the fourth antenna unit are arranged substantially in parallel.

32. The wireless communication device of claim 29, wherein the angle between the second projection on the second shielding surface of the central axis of the shell and the third antenna unit is 45 degrees, and the angle between the second projection on the second shielding surface of the central axis of the shell and the fourth antenna unit is 45 degrees.

33. The wireless communication device of claim 26, wherein the first antenna unit and the third antenna unit are substantially orthogonal.

34. The wireless communication device of claim 18, wherein the plurality of antenna units are arranged in an array.

35. The wireless communication device of claim 34, wherein the plurality of antenna units arranged substantially in parallel.

36. The wireless communication device of claim 35, wherein the angle between the first projection of the central axis of the shell on the first shielding surface and the plurality of antenna units is 45 degrees.

37. A wireless communication device for exchanging data with a plurality of users, the wireless communication device comprising:
a shell comprising a first surface and a second surface, wherein the first surface is adjacent to the second surface having an angle between the first surface and the second surface;
a data processing module;
a wireless communication module electrically connected to the data processing module;
a first antenna module being set up on the first surface and driven by the wireless communication module for emitting a first electromagnetic wave signal with a first frequency, wherein the first antenna module can switch into a first emitting mode and a second emitting mode, and a coverage angle of the radiation field of the first emitting mode is wider than a coverage angle of the radiation field of the second emitting mode;
a second antenna module being set up on the second surface and driven by the wireless communication module for emitting a second electromagnetic wave signal with a second frequency, wherein the first antenna module can switch into a first emitting mode and a second emitting mode, and a coverage angle of the radiation field of the first emitting mode is wider than a coverage angle of the radiation field of the second emitting mode;
a first switching circuit electrically connected to the first antenna module for switching the first antenna module into the first emitting mode or into the second emitting mode; and
a second switching circuit electrically connected to the second antenna module for switching the second antenna module into the first emitting mode or into the second emitting mode.

38. The wireless communication device of claim 37, wherein the shell further comprises a first shielding surface and a second shielding surface for shielding electromagnetic waves, wherein the first shielding surface is on the first surface, the second shielding surface is on the second surface, the first antenna module is set up on the first shielding surface, and the second antenna module is set up on the second shielding surface.

39. The wireless communication device of claim 38, wherein the data processing module comprises a calculating unit and a control unit, where the calculating unit calculates a first number of users who exchange data with the wireless communication device through the first antenna module and a second number of users who exchange data with the wireless communication device through the second antenna module, and the control unit controls the first switching circuit and the second switching circuit according to the first number and the second number.

40. The wireless communication device of claim 39, wherein if the first number is greater than the second number, the first antenna module is in the second emitting mode and the second module is in the first emitting mode.

41. The wireless communication device of claim 39, wherein if the first number and the second number are both less than a predetermined value, the first antenna module and the second antenna module are both in the second emitting mode.

42. The wireless communication device of claim 38, wherein the data processing module comprises a calculating unit and a control unit, where the calculating unit can calculate a first data flow of exchanging data with the wireless communication device through the first antenna module and a second data flow of exchanging data with the wireless communication device through the second antenna module, and the control unit controls the first switching circuit and the second switching circuit according to the first data flow and the second data flow.

43. The wireless communication device of claim 42, wherein if the first data flow is larger than the second data flow, the first antenna module is in the second emitting mode and the second antenna module is in the first emitting mode.

44. The wireless communication device of claim 42, wherein if the first data flow and the second data flow are both less than a predetermined value, the first antenna module and the second antenna module are both in the second emitting mode.

45. The wireless communication device of claim 37, wherein the shell further comprises a third surface adjacent to the second surface and an angle between the third surface and the second surface; and the wireless communication device further comprises:
a third antenna module which is set up on the third surface and driven by the wireless communication module for emitting a third electromagnetic wave signal with a third frequency, wherein the third antenna module can switch into a first emitting mode and a second emitting mode, and a coverage angle of the radiation field of the first emitting mode is wider than a coverage angle of the radiation field of the second emitting mode; and
a switching circuit electrically connected to the third antenna module for switching the third antennal module into the first emitting mode or into the second emitting mode.

46. The wireless communication device of claim 45, wherein the shell further comprises a first shielding surface, a second shielding surface, and a third shielding surface for shielding electromagnetic waves wherein the first shielding surface is on the first surface, the second shielding surface is on the second surface, the third surface is on the third surface, the first antenna module is set up on the first shielding surface, the second antenna module is set up on the second shielding surface, and the third antenna module is set up on the third shielding surface.

47. The wireless communication device of claim 46, wherein the data processing module comprises a calculating unit and a control unit, where the calculating unit calculates a first number of users who exchange data with the wireless communication device through the first antenna module, a second number of users who exchange data with the wireless communication device through the second antenna module, and a third number of users who exchange data with the wireless communication device through the third antenna module, and the control unit controls the first switching circuit, the second switching circuit, and the third switching circuit according to the first number, the second number, and the third number.

48. The wireless communication device of claim 46, wherein if the second number is larger than the first number and the third number, the second antenna module is in the second emitting mode, and the first and the third antenna modules are both in the first emitting mode.

49. The wireless communication device of claim 46, wherein the data processing module comprises a calculating unit and a control unit, where the calculating unit calculates a first data flow of exchanging data with the wireless communication device through the first antenna module, a second data flow of exchanging data with the wireless communication device through the second antenna module, and a third data flow of exchanging data with the wireless communication device through the third antenna module, and the control unit controls the first switching circuit, the second switching circuit, and the third switching circuit according to the first data flow, the second data flow, and the third data flow.

50. The wireless communication device of claim 49, wherein if the second data flow is greater than the first data flow and the third data flow, the second antenna module is in the second emitting mode, and the first and the third antenna modules are in the first emitting mode.

51. A wireless communication controlling method for controlling a wireless communication device to exchange data with a plurality of users, the wireless communication device comprising a shell having a first surface, a second surface adjacent to the first surface, and an angle between the first surface and a second surface; a first antenna module set up on the first surface for emitting a first electromagnetic wave signal with a first frequency, wherein the first antenna can switch into a first emitting mode and a second emitting mode; a second antenna module set up on the second surface for emitting a second electromagnetic wave signal with a second frequency, wherein the second antenna module can switch into the first emitting mode and the second emitting mode, a coverage angle of the first emitting mode being wider than a coverage angle of the second emitting mode, the communication controlling method comprising:
calculating a first number of users who exchange data with the wireless communication device through the first antenna module;
calculating a second number of users who exchange data with the wireless communication device through the second antenna module; and
controlling emitting modes of the first antenna module and the second antenna module according to the first number and the second number.

52. The wireless communication controlling method of claim 51, wherein if the second number is greater than the first number, the second antenna module is set in the second emitting mode.

53. The wireless communication controlling method of claim 51, wherein the shell of the wireless communication device further comprises a third surface adjacent to the second surface, an angle between the third surface and the second surface, and a third antenna module set up on the third surface for emitting a third electromagnetic wave signal with a third frequency; wherein third antenna module can switch into the first emitting mode and the second emitting mode; the controlling method comprising:
calculating a third number of users who exchange data with the wireless communication device through the third antenna module; and
controlling the emitting modes of the first antenna module, the second antenna module, and the third antenna module according to the first number, the second number, and the third number.

54. The wireless communication controlling method of claim 53, wherein if the second number is larger than the first number and the third number, the second antenna module is set in the second emitting mode, and the first and the third antenna module are set in the first emitting mode.

55. A wireless communication controlling method for controlling a wireless communication device to exchange data with a plurality of users, the wireless communication device comprising a shell having a first surface, a second surface adjacent to the first surface, and an angle between the first surface and a second surface; a first antenna module set up on the first surface for emitting a first electromagnetic wave signal with a first frequency, where the first antenna can switch into a first emitting mode and a second emitting mode; a second antenna module set up on the second surface for emitting a second electromagnetic wave signal with a second frequency, wherein the second antenna module can switch into the first emitting mode and the second emitting mode, a coverage angle of the first emitting mode is wider than a coverage angle of the second emitting mode, the communication controlling method comprising:
calculating a first data flow of exchanging data with the wireless communication device through the first antenna module;
calculating a second data flow of exchanging data with the wireless communication device through the second antenna module; and
controlling the emitting modes of the first antenna module and the second antenna module according to the first data flow and the second data flow.

56. The wireless communication controlling method of claim 55, wherein if the second data flow is greater than the first data flow, the second antenna module is set in the second emitting mode.

57. The wireless communication controlling method of claim 55, wherein the shell of the wireless communication device further comprises a third surface adjacent to the second surface, an angle between the third surface and the second surface, and a third antenna module set up on the third surface for emitting a third electromagnetic wave signal with a third frequency; wherein the third antenna module can switch into the first emitting mode and the second emitting mode; the controlling method comprising:
calculating a third data flow of exchanging data with the wireless communication device through the third antenna module; and
controlling the emitting modes of the first antenna module, the second antenna module, and the third antenna module according to the first data flow, the second data flow, and the third data flow.

58. The wireless communication controlling method of claim 57, wherein if the second data flow is larger than the first data flow and the third data flow, the second antenna module is set in the second emitting mode, and the first antenna module and the third module are set in the first emitting mode.
